(19) United States
(12) Patent Application Publication
(10) Pub. No.: US 2016/0328757 A1
(43) Pub. Date: Nov. 10, 2016

(54) Systems and Methods for Evaluating Service Providers

(71) Applicant: MASTERCARD INTERNATIONAL INCORPORATED, Purchase, NY (US)

(72) Inventors: Loralee Bodo, Hawthorne, NY (US); Marianne Iannace, North Salem, NY (US)

(21) Appl. No.: 14/707,309

(22) Filed: May 8, 2015

(51) Int. Cl. G06Q 30/02

(52) U.S. Cl. CPC G06Q 30/0282; G06Q 30/0201

(57) ABSTRACT

Systems and methods are provided for evaluating a service provider based on transaction data for the service provider. One exemplary method includes accessing transaction data for a payment account of a target service provider, where the transaction data represents multiple transactions from the payment account and the transactions involve multiple merchants; assigning the target service provider to a group of other service providers, selected from multiple groups of other service providers, based on the transaction data for the payment account of the target service provider; associating a rating for the selected group with the target service provider; and transmitting the rating.

### FIELD

The present disclosure generally relates to systems and methods for evaluating service providers (broadly, merchants) and, more particularly, to systems and methods for generating ratings of the service providers, as part of the evaluations, based on transaction data associated with the service providers.

### BACKGROUND

This section provides background information related to the present disclosure which is not necessarily prior art.

Service providers are known to provide services to consumers. Often, the services are provided to the consumers in their homes, when the consumers are either home or not home. However, in some cases, the services are provided to the consumers at locations away from their homes. Separately, advertisements from service providers, as well as reviews of the service providers, either published or via word-of-mouth, are used by consumers to select service providers to render desired services.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in evaluating service providers;

FIG. 2 is a block diagram of a computing device, that may be used in the exemplary system of FIG. 1;

FIG. 3 is an exemplary method, suitable for use with the system of FIG. 1, for generating a rating for a service provider, in connection with evaluating the service provider, based on transaction data associated with the service provider;

FIG. 4 is a block diagram illustrating service providers associated with particular groups (or clusters) of service providers, for example, in connection with application of the method of FIG. 3;

FIG. 5 is an exemplary method, suitable for use with the system of FIG. 1 and/or in connection with the method of FIG. 3, for identifying a service provider from a compilation of multiple service providers generated by a listing service; and

FIG. 6 is an exemplary interface suitable for use in connection with the method of FIG. 5, by a consumer, to search for a service provider, from a compilation of multiple service providers generated by a listing service.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Service providers are often unacquainted with consumers, prior to being employed by the consumers to provide desired services and/or related products (e.g., in the consumers' homes, away from the consumers' homes, etc.). Reviews of the service providers from prior consumers are often available to the subsequent consumers (e.g., via various listing services of such service providers, by word of mouth, etc.), and can be helpful in selecting from different service providers. However, the reviews often reflect particular interactions of the reviewing consumers with the service providers, and therefore typically represent only a glimpse into the reliability and/or trustworthiness (or lack thereof) of the service providers. To provide more complete representations of the service providers, the systems and methods herein evaluate the service providers, using ratings, based on transaction data associated with the service providers, where different transaction behaviors suggest different levels of reliability and/or trustworthiness. In addition, in some aspects, the systems and methods herein further bunch service providers together based on the transaction data, such that the resulting evaluations, and ratings, offer a relative metric by which consumers are able to compare service providers.

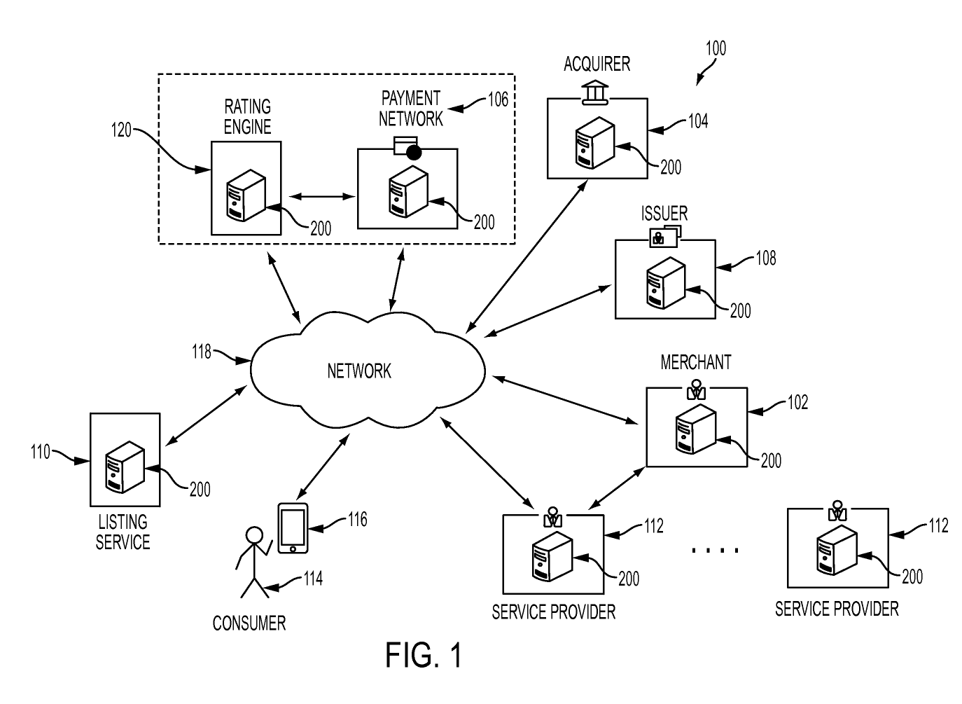

FIG. 1 illustrates an exemplary system 100 suitable for use in evaluating service providers, in which one or more aspects of the present disclosure may be implemented. Although, in the described embodiment, the system 100 is presented in one arrangement, in other embodiments the system 100 may be arranged otherwise depending, for example, on manners of accessing transaction data, authorization processes for payment transactions, modes of interaction between service providers and listing services, etc.

The illustrated system 100 generally includes a merchant 102, an acquirer 104, a payment network 106, an issuer 108, and a listing service 110. Briefly, the listing service 110 includes compilations of service providers 112 (broadly, merchants) that provide, to consumers, various desired services (and/or goods). A consumer 114 can then view the service providers 112, and the services/goods they provide, through the listing service 110 and, as desired, select one or more of the service providers 112 to perform desired services (e.g., in the consumer's home, away from the consumer's home, etc.). The consumer 114 may include, without limitation, a purchaser, a group of purchasers (e.g., a household, etc.), an institutional purchaser, a business, or any other entity that purchases services/products, etc.

While one consumer 114 is illustrated in FIG. 1, it should be appreciated that any number of consumers may be a part of the system 100, or parts of systems in other embodiments, consistent with the disclosure herein Likewise, a different number of merchants, acquirers, payment networks, issuers, and/or service providers may be included in systems in other embodiments.

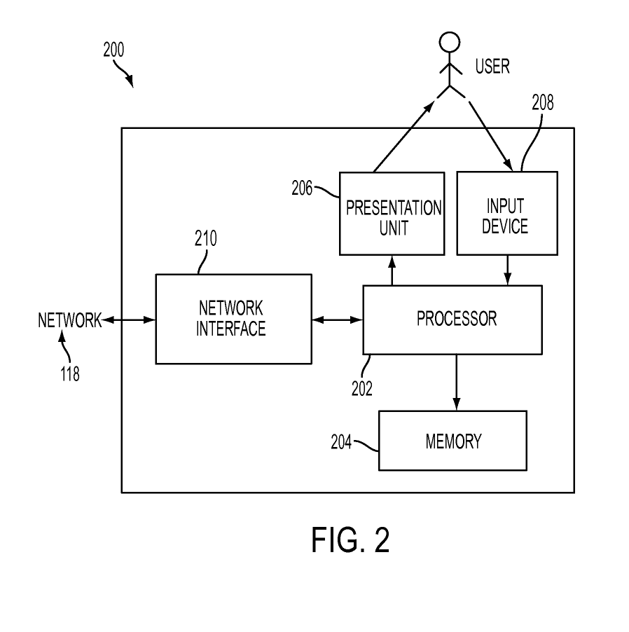

With continued reference to FIG. 1, each of the merchant 102, the acquirer 104, the payment network 106, the issuer 108, the listing service 110, and the service providers 112 are associated with a computing device 200 (which is described more hereinafter with reference to FIG. 2). In addition, the consumer 114 is associated with a computing device (illustrated as portable communication device 116 in FIG. 1, although other computing devices may be used), which is also implemented as the computing device 200. In general, the computing device 200 may include, for example, one or more servers, workstations, personal computers, laptops, smartphones (as illustrated in FIG. 1 for the consumer 114, for example), tablets, PDAs, personal navigation devices, etc. What's more, each computing device 200 may include a single computing device, or multiple computing devices located together or distributed across a geographic region. With that said, the system 100 and parts therein should not be considered to be limited to the computing device 200, as different computing devices and/or arrangements of computing devices may be used in other embodiments.

The computing device 200 associated with each of the merchant 102, the acquirer 104, the payment network 106, the issuer 108, the listing service 110, and the service providers 112 is coupled to network 118. In addition, the portable communication device 116 associated with the consumer 114 is also coupled to the network 118. The network 118 may include, without limitation, a local area network (LAN), a wide area network (WAN) (e.g., the Internet, etc.), a mobile network, and/or another suitable public and/or private network capable of supporting communication among two or more of the components illustrated in FIG. 1, or any combinations thereof. For example, network 118 may include multiple different networks, such as a private payment transaction network made accessible by the payment network 106 to the acquirer 104 and the issuer 108, and separately, the public Internet, which is accessible to the listing service 110 and/or a rating engine 120 configured to evaluate the service providers 112, as discussed herein.

As previously described, the listing service 110 includes compilations of the service providers 112, and the various services associated therewith, stored in computing device 200 (e.g., in memory of computing device 200, in a data structure associated with computing device 200, etc.). Exemplary services provided by the service providers 112 include, without limitation, child care services, adult/senior care services, pet care services, home care services, construction services, handyman services, house cleaning services, still other services, or products (e.g., products associated with services, etc.), etc. In addition, exemplary listing services include, for example, care.com, Angie's List™, Swifto Dog Walking, Running Paws, Molly Maid, Yelp, etc.

In various aspects, the listing service 110 publishes the compilations of the service providers 112 to consumers (e.g., consumer 114), via one or more interfaces, such as, for example, webpages or applications, in an effort to make the service providers 112, and their various services, more easily available to the consumers. The consumer 114 can then access, view, and search within, the compilations of service providers 112 at the listing service website, via the consumer's portable communication device 116. In addition, the consumer 114 can contact select ones of the service providers 112, through the listing service 110 (e.g., via the listing service website, etc.) or directly, to obtain desired services provided by the selected service providers 112.

It should be appreciated that the service providers 112 may pay the listing service 110 to be included in the compilations as part of a subscription, etc. (e.g., via payment accounts associated with the service providers 112), or inclusion in the compilations may be free (e.g., as part of a free subscription, etc.). Similarly, the consumer 114 may register with the listing service 110 to receive the compilations of the service providers 112, as part of a subscription (e.g., a paid subscription or otherwise, a free subscription, etc.). Or, the listing service 110 may provide the compilations of the service providers 112 through their website or applications, for example, as a service provided to the service providers 112 (e.g., as part of their subscription, etc.), and which may be linked to or separate from, in various embodiments, websites or applications specific to the individual service providers 112. In addition, the service providers 112 may directly communicate final evaluations (e.g., ratings, scores, etc.) to consumers, as determined by the rating engine 120, for example, through their websites or applications. Further, other relationships between the listing service 110, the service providers 112, and the consumer 114 may exist within the scope of the present disclosure.

In any case, in the system 100, the listing service 110 is configured, often by computer-readable instructions, to, among other functions described herein, receive and process requests from the service providers 112 to be included in the compilations and effect the compilations, as necessary.

Also in the illustrated system 100, each of the service providers 112 are associated with one or more payment accounts, through which they complete transactions for products, services, etc. In particular, each of the service providers 112 can initiate, when desired, a transaction by presenting a payment device, such as a credit card, a debit card, a pre-paid card, payment fob, a portable communication device with a payment account application, etc. to the merchant 102, or to other merchants (or to the listing service 110, as appropriate).

For example, when a service provider 112 desires to complete a transaction with the merchant 102, the service provider 112 presents a payment device to the merchant 102. The payment device may be presented directly to the merchant 102, or may be used remotely from the merchant 102, for example, via the network 118. The merchant 102 reads the payment device and/or receives payment account information for the service provider 112 and communicates an authorization request (e.g., including a payment account number (PAN) and an amount of the purchase, etc.) to the acquirer 104 to determine whether the payment account is in good standing and whether there is sufficient credit to complete the transaction. The acquirer 104, in turn, communicates the authorization request to the issuer 108, through the payment network 106, such as, for example, through MasterCard®, VISA®, Discover®, American Express®, etc. If the issuer 108 accepts the transaction, a reply authorizing the transaction is provided back to the merchant 102, thereby permitting the merchant 102 to complete the transaction. The transaction is later cleared and/or settled by and between the merchant 102, the acquirer 104, and the issuer 108 through similar interactions. If the issuer 108 declines the transaction, a reply declining the transaction is provided back to the merchant 102, thereby permitting the merchant 102 to stop the transaction.

While the above example transaction is described with reference to a credit account, it may instead involve a debit account or a pre-paid account in similar fashion. For example, for debit and pre-paid accounts, the transaction is substantially similar to the above, but may further include use of a personal identification number (PIN) authorization from the service provider 112 involved in the transaction and more rapid posting of the charge to the payment account, etc.

In the above example transaction, as part of the interactions among the merchant 102, the acquirer 104, the payment network 106, the issuer 108, and the service provider 112, transaction data is generated, collected, and stored. Transaction data is also generated, collected, and stored in a similar manner for other transactions in the system 100 (or in other systems). The transaction data represents at least a plurality of transactions, e.g., completed transactions, attempted transactions, etc. The transaction data, in this exemplary embodiment, is stored at least by the payment network 106 (e.g., in a data structure associated with the payment network 106 and/or the payment network computing device 200, etc.). Additionally, or alternatively, the merchant 102, the acquirer 104, and/or the issuer 108 may store the transaction data, or part thereof, in memory of their computing devices 200, or the transaction data may be transmitted between entities of system 100, as used or needed. For the above example transaction, the transaction data may include, without limitation, the PAN for the service provider 112 used in the transaction, an amount of the transaction, a merchant ID for the merchant 102, a merchant category code (MCC) for the merchant 102, a date/time of the transaction, other data, and/or combinations thereof. It should be appreciated that more or less information related to the transaction, as part of either authorization or clearing and/or settling, may be included in transaction data and stored within the system 100, at the merchant 102, the acquirer 104, the payment network 106 and/or the issuer 108, as desired or necessary.

In various exemplary embodiments, consumers (e.g., the consumer 114, the service providers 112 acting as consumers, etc.) involved in the different transactions herein agree to legal terms associated with their payment accounts, for example, during enrollment in their accounts, etc. In so doing, the consumers may agree, for example, to allow merchants, issuers of the payment accounts, payment networks, listing services, etc. to use data collected during enrollment and/or collected in connection with processing the transactions, subsequently for one or more of the different purposes described herein (e.g., for evaluating service providers, etc.).

Separately in the illustrated system 100, the payment network 106 includes the rating engine 120 associated therewith (as indicated by the broken lines in FIG. 1) and configured, often by computer-readable instructions, to, among other functions described herein, evaluate the service providers 112 (e.g., a target one of the service providers 112, etc.) based on the collected transaction data for the service providers 112 and, based on the evaluations, transmit and/or publish ratings (or scores) for the service providers 112 to the listing service 110 for association with the service providers 112 in the compilations. With that said, the rating engine 120 may be incorporated into the computing device 200 of the payment network 106, or it may be a separate computing device located together with and/or distributed apart from the payment network computing device 200. In addition, in other embodiments, the rating engine 120 may be incorporated in other entities of the system 100, or even in entities not shown in the system 100 but which still interact with system 100, or it may be stand alone. In at least one embodiment, the rating engine 120 is incorporated into the listing service 110.

In the system 100, when a service provider 112 is included in a compilation of service providers 112 by the listing service 110, potentially regardless of whether a payment from the service provider 112 for such inclusion is required or received, the listing service 110 requests, and receives from the service provider 112, at least one payment account associated with the service provider 112. The listing service 110 then communicates, via the network 118, a request to the rating engine 120 to evaluate the service provider 112 (for inclusion in the compilation). The request includes various data relating to the service provider 112, including a PAN (or PANs) for the payment account (or payment accounts) provided by the service provider 112, as well as other information about the service provider 112 (e.g., services provided, contact information, service rates, other information, etc.). Upon receipt, the rating engine 120 accesses, in the payment network 106 (e.g., in the payment network computing device 200, etc.), stored transaction data for the service provider 112 associated with the service provider's payment account(s). In at least one embodiment, the rating engine 120 accesses transaction data for multiple payment accounts associated with the service provider 112, through the payment network 106 or through multiple payment networks.

The rating engine 120 then generates (or associates) a rating (e.g., a number rating on a predefined scale, a letter rating on a predefined scale, a symbol-type rating, etc.) for (or with) the service provider 112, based on the accessed transaction data. This will be described in more detail hereinafter in connection with method 300. It should be appreciated that the transaction data accessed by the rating engine 120 may include any desired transaction data including, for example, transaction data satisfying one or more predefined criteria (e.g., transaction data for purchases made during a predefined interval, transaction data for purchases made at predefined merchants, transaction data for purchases associated with a predefined MCC, etc.). In one example, the transaction data accessed by the rating engine 120 includes all transaction data to one or more payment accounts associated with the service provider 112, over the last thirty-six months. Of course, it should be appreciated that transaction data over different intervals may also (or alternatively) be used, including, for example, transaction data over six-month time periods, over twelve-month time periods, over eighteen-month time periods, over twenty-four month time periods, etc. Further, in some embodiments, once the rating engine 120 generates a rating for the service provider 112, based on the accessed transaction data, the rating engine 120 may update the rating, as desired (e.g., continuously, at predefined intervals (e.g., daily, weekly, monthly, quarterly, annually, etc.), upon a new search at the listing service 110, etc.), by again accessing transaction data, so that recalculated and updated ratings are provided/available to the listing service 110 for the service provider 112 (e.g., to account for any changes in purchasing behavior of the service provider 112, etc.).

Once the rating is generated, originally or updated (or associated with the service provider 112), the rating engine 120 communicates the rating for the service provider 112 back to the listing service 110, via the network 118. Listing service 110 appends the rating to the service provider 112, in the appropriate compilation of service providers, for example, provided through the listing service's website or application. As such, when the consumer 114 accesses the compilations of service providers, at the listing service 110, the rating for the service provider 112 will be available for viewing, review and/or consideration.

FIG. 2 illustrates the exemplary computing device 200, associated with the various entities shown in FIG. 1. It should be appreciated, however, that other computing devices may be associated with one or more entities shown in FIG. 1, in addition to computing device 200 or instead of computing device 200. Further, different components and/or arrangements of components may be used in other computing devices associated with one or more of the entities shown in FIG. 1.

The illustrated computing device 200 includes a processor 202 and a memory 204 coupled to the processor 202. The computing device 200 is programmable to perform one or more operations described herein by programming the processor 202 and/or the memory 204. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. It should be appreciated that the above examples are exemplary only, and thus are not intended to limit in any way the definition and/or meaning of processor.

The memory 204, as described herein, is one or more devices that enable information, such as computer-executable instructions and/or other data, to be stored and retrieved. The memory 204 may be configured to store, without limitation, transaction data, indices relating to service providers and/or groups of service providers, service provider scores and/or ratings, compilations of service providers, and/or other types of data suitable for use as described herein, etc. It should be appreciated that the memory 204 may include a variety of different memories, each implemented in one or more of the functions or processes described herein. In addition, the memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media.

Further, computer-readable media may, in some embodiments, be selectively insertable to and/or removable from the computing device 200 to permit access to and/or execution by the processor 202 (although this is not required). Further, in various embodiments, computer-executable instructions and/or other data may be stored in the memory 204 for execution by the processor 202 to cause the processor 202 to perform one or more of the functions described herein, such that the memory 204 is a physical, tangible, and non-transitory computer-readable media.

The computing device 200 also includes a presentation unit 206 and an input device 208 coupled to the processor 202.

The presentation unit 206 outputs information and/or data (e.g., indices, scores, ratings, etc. for service providers 112; transaction data; etc.) to a user (e.g., an individual associated with one or more of the entities illustrated in FIG. 1, with other individuals, with other computing devices, etc.) by, for example, displaying, audibilizing, and/or otherwise outputting the information and/or data. In some embodiments, the presentation unit 206 may comprise a display device such that various interfaces (e.g., applications or webpages, etc.) may be displayed at computing device 200, and in particular at the display device, to display such information and/or data, etc. And in some examples, the computing device 200 may also (or alternatively) cause the interfaces to be displayed at a display device of another computing device, including, for example, a server hosting a website having multiple webpages, etc. With that said, the presentation unit 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 206 may include multiple devices.

The input device 208 is configured to receive input from the user. For example, the input device 208 may be configured to receive any desired type of input from the user, for example, as part of creating service provider registrations, creating requests for evaluating service providers, creating reviews, evaluating service providers, viewing compilations of service providers, viewing particular details of select service providers, viewing payment transaction details, payment account details, etc. In the exemplary embodiment, the input device 208 may include, without limitation, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both the presentation unit 206 and the input device 208.

With continued reference to FIG. 2, the computing device 200 also includes a network interface 210 coupled to the processor 202. The network interface 210 may include, without limitation, a wired network adapter, a wireless network adapter, a mobile telecommunications adapter, or other device capable of communicating to one or more different networks, including the network 118. In some exemplary embodiments, the computing device 200 includes the processor 202 and one or more network interfaces incorporated into or with the processor 202.

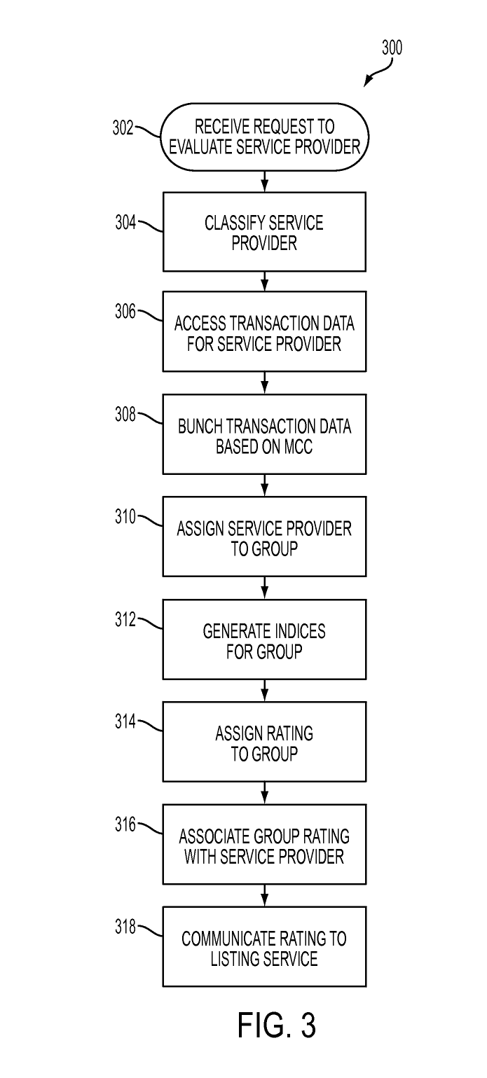

FIG. 3 illustrates exemplary method 300 for evaluating a service provider 112, by generating a rating for the service provider 112 based on transaction data associated with the service provider 112. By using the transaction data for the service provider 112, as a basis for generating the rating, a more complete representation of the service provider 112 can be provided, as different transaction behaviors of the service provider 112 can be taken into account to thereby capture different levels of reliability and/or trustworthiness.

The method 300 can be implemented in connection with the system 100 of FIG. 1 and is described herein as implemented in the payment network 106 of the system 100 (e.g., in the rating engine 120 associated with the payment network 106, etc.), with further reference to the merchant 102, the listing service 110, the service providers 112, and the consumer 114. In addition, for purposes of illustration, the exemplary method 300 is described herein with reference to the computing device 200. However, the methods herein, including method 300, should not be understood to be limited to the exemplary system 100, or the exemplary computing device 200. Similarly, the systems and the computing devices herein should not be understood to be limited to the exemplary method 300.

In the method 300, a service provider 112 initially registers with the listing service 110 for inclusion in one or more compilations of service providers supported and maintained by the listing service 110 (e.g., for publication to consumers, etc.). In so doing, the listing service 110 requires various data from the service provider 112. As such, the registration can include, for example, biographical information about the service provider 112, information about one or more services offered by the service provider 112, contact information for the service provider 112 (e.g., phone numbers, an address, websites, etc.), various review sources for the service provider 112, etc. In addition in the method 300, the registration includes identifying information for one or more payment accounts associated with the service provider 112 (e.g., in connection with facilitating or setting up payment for the registration, or as part of a particular request/requirement when generating the registration, etc.), and appropriate permissions to access transaction data associated with the one or more payment accounts (e.g., for use in the method 300 as described hereinafter, etc.).

Then, when the listing service 110 includes the service provider 112 in an appropriate compilation of service providers (or before or after), the listing service 110 communicates with the rating engine 120, at the payment network 106, to evaluate the service provider 112 and determine an appropriate rating (or score) to be applied to (or associated with) the service provider 112 (e.g., in connection with the service provider's listing in the compilation, etc.). In some implementations of the method 300, the listing service 110 may also communicate with the rating engine 120 to update an existing rating (or score) for the service provider 112 in response to a search at the listing service 110 (e.g., by the consumer 114, etc.) involving the service provider 112 (e.g., a search directly for the service provider 112, a search involving an industry related to the service provider 112, etc.). In still other implementations of the method 300, the listing service may also (or alternatively) communicate with the rating engine 120 to update an existing rating (or score) for the service provider 112 at predefined intervals (e.g., daily, weekly, monthly, quarterly, annually, etc.).

In the method 300, the communication from the listing service 110 includes the listing service 110 transmitting a request, from computing device 200 and via the network 118, to the rating engine 120 to evaluate the service provider 112 and determine the rating for the service provider 112 (or update an existing rating for the service provider 112). The rating engine 120, in turn, receives the request to evaluate the service provider 112 at 302. In other embodiments, for example, where the rating engine 120 is incorporated with the listing service 110, the request to evaluate the service provider 112 may be internal to the listing service 110. At this time (or earlier or later in the method 300), the rating engine 120 also classifies the service provider 112, at 304, based on a type of service provided by the service provider 112 (e.g., based on data provided by the service provider 112 at registration, etc.). Exemplary classifications include, without limitation, child care services, adult/senior care services, pet care services, home care services, construction services, handyman services, house cleaning services, etc.

The request received by the rating engine 120 includes various data relating to the service provider 112 including, for example, a PAN (or PANs) for the payment account (or payment accounts) provided by the service provider 112 at registration, services provided by the service provider 112, contact information for the service provider 112, service rates for the service provider 112, other information, etc. Often, the request from the listing service 110 will also verify, to the service provider 112 or others, that authorization has been received from the service provider 112 to access the transaction data associated with the one or more payment accounts provided by the service provider 112 at registration.

In response to the request, the rating engine 120, at 306, accesses transaction data for the service provider 112 and, in particular, transaction data for the payment account(s) associated with the service provider 112 (as provided to the listing service 110, by the service provider 112, during registration). In the method 300, where the rating engine 120 is incorporated in the payment network 106, the access may include a request for the transaction data, by the rating engine 120, to a particular data structure of the payment network 106 (e.g., in computing device 200, etc.). Additionally, or alternatively (e.g., where the rating engine 120 is separate from the payment network 106, etc.), the access may include a request for the transaction data, by the rating engine 120, to the payment network 106 via, for example, an application program interface (API) interaction to the payment network 106, etc.

The rating engine 120 may access any desired transaction data for the payment account(s) associated with the service provider 112. For example, the rating engine 120 may access all available transaction data for all payment accounts identified by the service provider 112 at registration, or transaction data for a particular interval (e.g., the last 36 months, etc.), etc. As can be appreciated, as more transaction data is made available to the rating engine 120, the evaluation (and rating) for the service provider 112 becomes more accurate. As such, it may be beneficial for the listing service 110 to request multiple payment accounts from the service provider 112, in various embodiments, during registration, to make such additional transaction data available to the rating engine 120.

As previously described in connection with the system 100, transaction data is generated, collected, and stored for transactions between the service provider 112 (or other service providers) and the merchant 102 (or other merchants, etc.). The transaction data corresponds to one or more of the payment accounts associated with the service provider 112, identified during registration with the listing service 110. And, the transaction data represents multiple transactions from the one or more payments accounts, and involving the merchant 102 (and/or multiple additional merchants). With that said, the transaction data accessed by the rating engine 120, in the method 300, may include, for each transaction (and without limitation), the PAN for the service provider's payment account used in the transaction, an amount of the transaction, a merchant ID for a merchant (or for various merchants) involved in the transaction, a MCC for a merchant involved in the transaction, a date/time of the transaction, other data, and/or combinations thereof.

With continued reference to FIG. 3, upon accessing the transaction data for the service provider 112 at 306, the rating engine 120 bunches the data at 308. In connection therewith, the rating engine 120 may also store the bunched data in memory 204 of the engine's computing device 200 for subsequent use (e.g., with bunched data for other service providers, etc.).

In the method 300, the rating engine 120 bunches the transaction data for the service provider 112, for each transaction extracted, based on the MCC for the merchant involved in the transaction. In so doing, the rating engine 120 identifies all transactions at merchants having the same MCC, and then bunches them together for processing. It should be appreciated that the rating engine 120 may bunch the transaction data based on all available MCCs (regardless of whether or not the accessed transaction data involves all available MCCs), or on only those MCCs appearing in the accessed transaction data for the service provider 112, or further, and more often, on certain predefined MCCs. For example, the rating engine 120 may bunch the accessed transaction data based on select MCCs (e.g., Bars/Taverns, Casinos, Dating Sites, Health Clubs, Specialty Grocery, Pet Stores, Coffee Shops, Dance Studios, etc.). In so doing, the select MCCs may be tailored to the service provider 112 and the services offered by the service provider 112, etc. Then, accessed transaction data associated with other, unselected, MCCs may be discarded or otherwise processed by the rating engine 120. Generally, the select MCCs tend to be indicative of certain behaviors of the service provider 112, which may be considered indicative, in some embodiments, of reliability and/or trustworthiness, or not.

In other embodiments, the rating engine 120 may bunch transaction data based on other criteria related to the merchant(s) involved in the transactions and/or the service provider 112 and/or the particular transactions associated with the transaction data.

Next, at 310, the rating engine 120 assigns the service provider 112 to a group (or cluster) of other service providers having similar attributes to those of the service provider 112. For example, the service provider 112 may be assigned to a group of other service providers associated with the same, or a similar, MCC to that of the service provider 112. And/or, the service provider 112 may be assigned to a group of other service providers having similar spending behaviors to those of the service provider 112. Here, the service provider 112 may be assigned to a group of other service providers that make transactions at the same or similar merchants as the service provider 112 (e.g., based on MCC of the merchants, etc.), that make similar numbers of transactions as the service provider 112 (e.g., similar total transactions, similar average transactions, etc.), that incur similar spend amounts as the service provider 112 (e.g., similar total spend, similar average spend, etc.), etc.

The group to which the service provider 112 is assigned, at 310, by the rating engine 120 is selected from multiple different predefined groups of service providers. As such, the various service providers have already been assigned to these groups because they have similar attributes. Such assignments may be done, for example, in accordance with method 300, or otherwise. In some embodiments, the number of available predefined groups, available for selection by the rating engine 120, may be defined prior to grouping the service provider 112, or it may be based on the particular service provider 112 to be grouped (e.g., based on MCC, based on services provided, etc.). Further, in various embodiments, the predefined groups may be created, in particular, for certain types/categories of service providers, specifically or generally, such as, for example, plumbers, contractors, etc. Here, upon grouping the service provider 112, the service provider 112 is then matched not only with other service providers having similar spending behavior, but with other service providers offering similar services.

In particular in the method 300, the rating engine 120 compares the accessed transaction data for the service provider 112, in multiple dimensions (e.g., within different MCCs, based on transaction numbers, based on transaction amounts, etc.), to transaction data for the other service providers in the multiple different predefined groups (where their transaction data is also bunched, based on MCC, in a similar manner to the transaction data for the service provider 112, etc.). The transaction data for the service providers in the predefined groups may include historical transaction data (e.g., transaction data previously accessed by the rating engine 120 in connection with rating the other service providers, transaction data provided by third-party entities, etc.), or it may include current transaction data accessed by the rating engine 120 at the same time the rating engine 120 accesses the transaction data for the service provider 112 (e.g., such that the same predefined intervals of transaction data can be used for all service providers in the analysis, etc.). Then, based on the comparison, the rating engine 120 assigns the service provider 112 to a select one of the predefined groups that provides a best fit (or best match) to the transaction data of the service provider 112 across all of the multiple dimensions. It should be appreciated that various different statistical methods can be used to facilitate assignment of the service provider to a group, such as, for example, k-means clustering, etc., in which homogeneous segments of transaction data are grouped together based on how close the data is to each other.

After the service provider 112 is assigned to a group, the rating engine 120 generates indices (e.g., at least one index, multiple indices, etc.), at 312, for the group based on the bunched transaction data for the service provider 112 and the bunched transaction data for the other service providers in the group. In particular, in the method 300, an index is generated for each selected MCC with which the accessed transaction data for the service provider 112 is associated (however, indices could be generated for other data groupings in other embodiments). In so doing, the indices may be generated based on amounts spent by the service providers 112 at merchants associated with the particular MCCs (e.g., amounts spent per transaction, total amounts spent, total amounts spent over a predefined interval, average amounts spent, etc.), numbers of transactions made by the service providers (e.g., total numbers of transactions, total numbers of transactions over a predefined interval, average numbers of transactions, etc.), times of the day the transactions were made, days of the week the transactions were made, frequencies of the transactions, etc.

The indices may be generated by the rating engine 120 in a number of different manners, with the indices generally indicative of a propensity of the service providers in the group to transact with merchants of the particular type indicated by the corresponding MCCs for which the indices were generated. For example, the rating engine 120 may utilize operations such as summing, averaging, subtracting, weighting, etc. to generate (or as part of generating) the indices. In addition, the indices may be generated in the same or different manners (e.g., they may be weighted differently, etc.) for different MCCs, or for different compilations, or even different groups, of service providers (e.g., based on particular fields of the involved service providers, particular professions of the involved service providers, etc.), etc. However, generally, in embodiments where the indices are compared between different groups of service providers, especially those having service providers in the same profession, etc., the indices for each of the groups are generated in the same manner in order to normalize them.

At 314, the rating engine 120 assigns a rating (or score) to the group of service providers (to which the service provider 112 is assigned), based on the generated indices. The rating may include, without limitation, a number rating on a predefined scale, a letter rating on a predefined scale, a symbol-type rating, or other rating (or score) within the scope of the present disclosure.

At this point it should be appreciated that, in connection with assigning the rating to the group, transactions by the service providers in the group (including transactions by the service provider 112), at merchants with various different MCCs, may be indicative of different behaviors of the service providers. In particular, transactions involving certain MCCs may be more indicative of reliability and/or trustworthiness concerns, than transactions involving other MCCs. For example, multiple transactions at bars/taverns by a service provider, at particular times during a workday, may be more instructive of a poor rating for the service provider as he/she would typically be expected to provide his/her services during those same times during the work day, than multiple transactions to a specialty grocery store in the evening. Further, in connection with assigning the rating to the group, the rating engine 120 may include weighting factors for different ones of the MCCs, as desired, or may use other criteria to account therefore. For example, an average spend at a health store may be multiplied by three, while an average spend at a dance studio may be multiplied by two and an average spend at a casino may be multiplied by four. Moreover, different MCCs may be assigned, or in a sense weighted (e.g., as a negative or a positive, etc.), to reflect desirable MCCs versus undesirable MCCs.

As an example, the rating engine 120 may initially assign a default rating to the group (e.g., a rating of three, when a rating scale of one to five is applied; etc.), and then adjust the default rating based on the group's indices and their relative comparison to corresponding indices of other groups (e.g., all other groups available to the rating engine, other groups with service providers having similar MCCs, etc.). Here, the rating engine 120 may adjust the default rating up (i.e., increase the default rating) for each of the group's indices that is above a corresponding mean value of the indices of all of the involved groups. And, the rating engine 120 may adjust the default rating down (i.e., decrease the default rating) for each of the group's indices that is below a corresponding mean value of the indices of all of the involved groups. Further, the particular adjustment up or down may also depend on the particular MCC involved in the index comparison and/or its weighting (if any), the size of the difference between the index and the corresponding mean value, etc. For example, for an MCC considered associated with a positive attribute, the rating engine 120 may adjust the default rating up when the group's index for the MCC is above a corresponding mean value of the indices of all the involved groups. Alternatively, for an MCC considered associated with a negative attribute, the rating engine 120 may adjust the default rating up when the group's index for the MCC is below a corresponding mean value of the indices of all the involved groups.

With further reference to FIG. 3, the rating engine 120 associates the rating assigned to the group with the service provider 112 at 316. The rating engine 120 then communicates (or transmits) the rating for the service provider 112 back to the listing service 110 (via the network 118), at 318. And, the listing service 110 associates, or appends, the rating with the service provider 112, in the compilation of services providers provided, for example, through the listing service's website. The listing service 110 may associate the exact rating provided by the rating engine 120 with the service provider 112. Or, the listing service 110 may use the rating, provided by the rating engine 120, as part of an additional evaluation algorithm applied to the service provider 112. In either case, when the consumer 114 accesses the compilation of service providers, at the listing service 110, the rating for the service provider 112 will be available for review and/or consideration.

It should be appreciated that the rating, assigned by the rating engine 120 to the group and then associated with the service provider 112, is based on the transaction data for the service provider 112, in comparison to transaction data for multiple other service providers. As such, the rating effectively takes into account different transaction behaviors of the service provider 112, which may be indicative of different levels of reliability and/or trustworthiness. In addition, by communicating the rating for the service provider 112 to the listing service 110 for inclusion in compilations of service providers, a relative metric is provided by which consumers are able to compare service providers.

The method 300 is described herein in connection with assigning the rating to the group of service providers (to which the service provider 112 is assigned), at 314, based on the generated indices for the group. In some implementations of the method 300, however, the group to which the service provider 112 is assigned may already be associated with a rating (e.g., based on historical transaction data, based on indices generated for the group before the service provider 112 is assigned to the group, etc.). In these implementations, the rating for the group may be determined in the same manner as described herein (but simply before assigning the service provider 112 to the group). Then, in connection with evaluating the service provider 112, once the service provider is assigned to the group at 310 (based on the transaction data for the service provider 112), the rating of the group is associated with the service provider at 314 and/or 316.

As previously described, it should also be appreciated that, in some implementations, the rating engine may refresh or update the rating (or score) for the service provider 112, as desired (e.g., continuously, at predefined intervals (e.g., daily, weekly, monthly, quarterly, annually, etc.), upon a new search at the listing service 110, etc.), by again accessing transaction data, so that recalculated and updated ratings are provided/available to the listing service 110 for the service provider 112 (e.g., to account for any changes in purchasing behavior of the service provider 112, etc.).

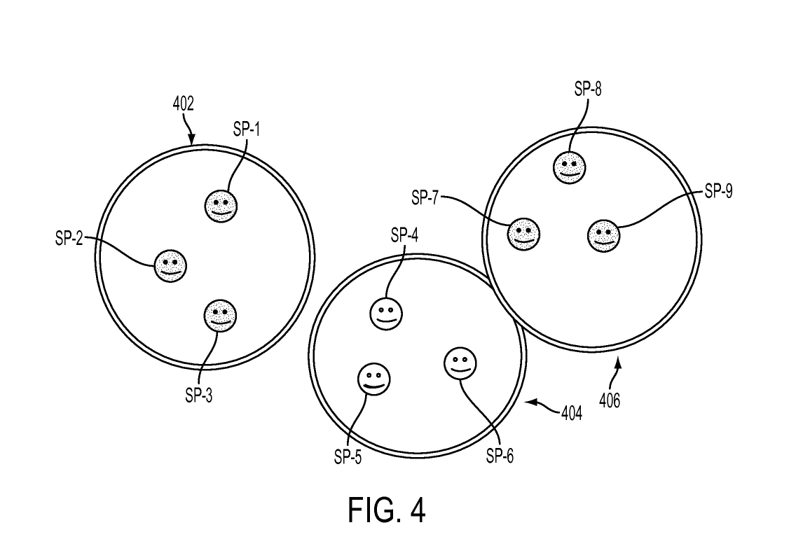

With reference now to Tables 1-4 and FIG. 4, an example implementation of method 300 will be described in connection with evaluating service provider SP-1. Upon receiving a request to evaluate the service provider SP-1, the rating engine 120 accesses transaction data from the payment network 106 (or other entity, such as issuer 108, etc.), for all transactions made by the service provider SP-1 over the last 36 months. As shown in Table 1, the rating engine 120 then bunches (e.g., sums, weights, combines, etc.) the transaction data based on MCC for each associated transaction. In this example, four particular MCCs are used: Bars/Taverns, Casinos, Specialty Grocery, and Health Clubs. And, the transaction data for the Bars/Taverns category includes the total number of transactions made by the service provider SP-1 at bars and/or taverns; the transaction data for the Casinos category includes the total amount spent by the service provider SP-1 at casinos; the transaction data for the Specialty Grocery category includes the total number of transactions made by the service provider SP-1 at specialty grocery stores; and the transaction data for the Health Clubs category includes the total amount spent by the service provider SP-1 at health clubs.

TABLE 1

| | | | MCC: | |
|---|---|---|---|---|
| | MCC: | MCC: | Specialty | MCC: |
| | Bars/Taverns | Casinos | Grocery | Health Clubs |
| | (Total | (Total | (Total | (Total |
| | Transactions) | Spend ($)) | Transactions) | Spend ($)) |
| SP-1 | 25 | 15,000 | 20 | 500 |

Next, the rating engine 120 assigns the service provider SP-1 to one of three different groups (Groups A-C) of other service providers (SP-2-SP-9) based on the service providers' transaction data. Table 2 illustrates the three groups of other service providers, and transaction data for each of the service providers (e.g., accessed by the rating engine 120, from the payment network 106 (or other entity, such as issuer 108, etc.), at the same time the rating engine 120 accessed the transaction data for the service provider SP-1; etc.). As previously described, assigning the service provider SP-1 to one of Groups A-C is generally based on the relationship of the transaction data for the service provider SP-1 to the transaction data for the other service providers SP-2-SP-9, and various similarities therebetween. In this example, the transaction data for service provider SP-1 is more similar to the transaction data for the service providers SP-2 and SP-3 in Group A, than to the service providers SP-4-SP-6 in Group B or the service providers SP-7-SP-9 in Group C. As such, the rating engine 120 groups the service provider SP-1 with the service providers SP-2 and SP-3 in Group A. FIG. 4 illustrates the service providers, SP-1 through SP-9 assigned to Groups A-C (identified as 402-406).

TABLE 2

| | | | | | MCC: |
|---|---|---|---|---|---|
| | | | MCC: | MCC: | Health |
| | | MCC: | Casinos | Specialty | Clubs |
| | | Bars/Taverns | (Total | Grocery | (Total |
| | Service | (Total | Spend | (Total | Spend |
| Group | Provider | Transactions) | ($)) | Transactions) | ($)) |
| A | SP-2 | 30 | 25,122 | 45 | 1,500 |
| | SP-3 | 20 | 22,234 | 33 | 2,000 |
| B | SP-4 | 1 | 1,500 | 350 | 10,000 |
| | SP-5 | 0 | 2,500 | 540 | 12,000 |
| | SP-6 | 3 | 7,000 | 444 | 20,000 |
| C | SP-7 | 14 | 14,000 | 340 | 4,000 |
| | SP-8 | 18 | 7,777 | 124 | 4,400 |
| | SP-9 | 12 | 12,500 | 222 | 15,000 |

After the service provider SP-1 is assigned to Group A, the rating engine 120 generates an index for each of the four particular MCCs (Bars/Taverns, Casinos, Specialty Grocery, and Health Clubs), for each of the Groups A-C. Based on the transaction data used for each of the service providers, the indices for the Bars/Taverns category and the Specialty Grocery category are transaction number indices. And, the indices for the Casinos category and the Health Clubs category are transaction amount indices.

In this example, each index is generated by the rating engine 120 as an average value of the transaction data for all of the service providers in Groups A-C. For example, for the Bars/Taverns category, the total number of transactions for Group A is 75; the total number of transactions for Group B is 4; and the total number of transactions for Group C is 44. As such, the average of the total number of transactions for the Bars/Taverns category, for all Groups A-C, is 41 (i.e., (75+4+44)/3). The index for Group A is then 1.83 (i.e., 75/41); the index for Group is then 0.10 (i.e., 4/41); and the index for Group C is then 1.07 (i.e., 44/41). The indices for the Casinos, Specialty Grocery, and Health Clubs categories are generated in a similar manner, with the resulting indices shown in Table 3.

TABLE 3

| Service | MCC: | | MCC: | MCC: |
|---|---|---|---|---|
| Provider | Bars/ | MCC: | Specialty | Health |
| Group | Taverns | Casinos | Grocery | Clubs |
| A | 1.83 | 2.00 | 0.14 | 0.17 |
| B | 0.10 | 0.35 | 1.89 | 1.81 |
| C | 1.07 | 0.65 | 0.97 | 1.01 |

Then, based on the generated indices, the rating engine 120 assigns a relative star rating to each of the Groups A-C, on a rating scale of one to ten stars (with a minimum possible rating being one star, and a maximum possible rating being ten stars. In this example, the rating engine 120 initially assigns a default rating of five stars to each of the Groups A-C, and then adjusts the default rating based on the relationship of each of the indices to a corresponding mean value, for each MCC (i.e., 1 in this example). In addition in this example, the rating engine 120 considers (e.g., weights, etc.) the Specialty Grocery category and the Health Clubs category as being associated with positive attributes of service providers, and the Bars/Taverns category and the Casinos category as being associated with negative attributes of service providers. As such, in assigning (or generating) the star rating for each of Groups A-C, the rating engine 120 adjusts the default star rating up one star for each index in the Specialty Grocery category and in the Health Clubs category that is above the mean value and down one star for each index that is below the mean value. And conversely, the rating engine 120 adjusts the default star rating down one star for each index in the Bars/Taverns category and in the Casinos category that is above the mean value and up one star for each index that is below the mean value. With that in mind, the rating engine assigns a one-star rating to Group A; a nine-star rating to Group B; and a five-star rating to Group C. The resulting ratings are illustrated in Table 4. The one-star rating for Group A is then associated with the service provider SP-1 (e.g., by the rating engine computing device 200, etc.) for further processing.

TABLE 4

| Service | |
|---|---|
| Provider | Star |
| Group | Rating |
| A | [symbol] |
| B | [symbol] [symbol] [symbol] [symbol] [symbol] [symbol] [symbol] [symbol] [symbol] |
| C | [symbol] [symbol] [symbol] [symbol] [symbol] |

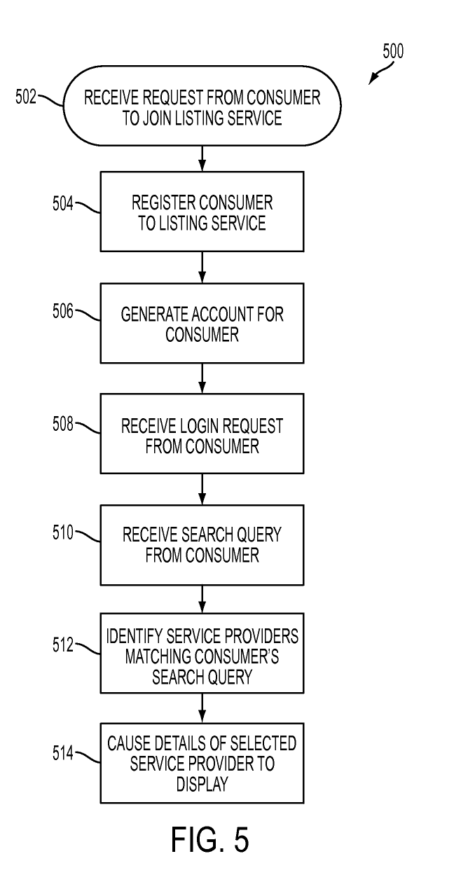

FIG. 5 illustrates an exemplary method 500 for identifying a service provider 112 at the listing service 110, from a compilation of multiple service providers 112 (as generated and maintained by the listing service 110). The method 500 can be implemented in connection with the system 100 of FIG. 1 and is described herein as implemented in the listing service 110 of the system 100 (e.g., in the computing device 200 associated with the listing service 110, etc.), with further reference to the service providers 112 and the consumer 114. In addition, for purposes of illustration, the exemplary method 500 is described herein with reference to the computing device 200. However, the method 500 (or, for that matter, any other method herein) should not be understood to be limited to the exemplary system 100, or the exemplary computing device 200. Similarly, the systems and the computing devices herein should not be understood to be limited to the exemplary method 500.

As shown in FIG. 5, in the illustrated method 500, the listing service 110 initially receives a request from the consumer 114 to join the listing service 110, at 502. In response, the listing service 110 registers the consumer 114 to the listing service 110 at 504, and generates an account for the consumer 114 at 506. The registration may include, for example, biographical information about the consumer 114, contact information for the consumer 114, payment account information for the consumer 114 (e.g., in connection with fee-based subscriptions, etc.), etc.

Once the consumer 114 is registered to the listing service 110, the consumer 114 can access the compilations of service providers maintained by the listing service 110. For example, when the consumer 114 desires to establish such access, the consumer 114 provides a login request to the listing service 110, which is received at 508. In connection with the login request, the consumer 114 may enter a username and password (or other appropriate credentials) to an interface that is caused to be displayed, by the listing service 110 (e.g., by the processor 202 of the listing service computing device 200, etc.), at the consumer's portable communication device 116 (or any other computing device associated with the consumer 114 and used, for example, by the consumer 114 in connection with the login request), upon request.

Next in the method 500, once the consumer 114 provides valid login credentials, the listing service 110 (e.g., the processor 202 of the listing service computing device 200, etc.) causes a search interface to display at the consumer's portable communication device 116, in this exemplary embodiment. In connection therewith, the consumer 114 can submit a search query, with particular search parameters, to the listing service 110 (which is received by the listing service 110 at 510, in the method 500).

In response, the listing service 110 (e.g., the processor 202 of the listing service computing device 200, etc.) identifies one or more service providers, at 512, that match the consumer's search parameters, and causes the one or more service providers to display to the consumer 114, at the consumer's portable communication device 116, via one or more additional interfaces. In addition, ratings (as determined herein, for example, in connection with system 100, method 300, etc.) for the one or more service providers are also available to the consumer 114, through this display, for viewing, review and/or consideration. As desired, the consumer 114 can then select one or more of the service providers to receive additional information and/or to contact the service providers to arrange for providing desired services. In connection therewith, the listing service 110 may cause the requested information to display at the portable communication device 116 associated with the consumer 114, at 514, as desired.

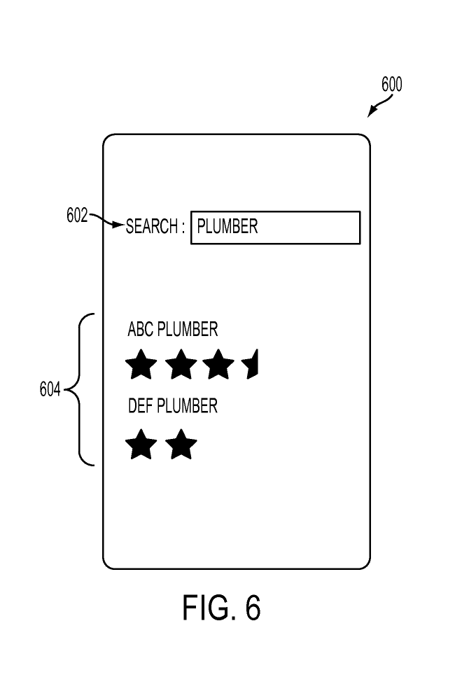

FIG. 6 illustrates an exemplary search interface 600 that can be used in connection with the method 500. In the interface 600, a search feature 602 is provided for the consumer 114 to enter the desired search parameters (e.g., plumber, etc.) for use by the listing service 110 (e.g., by the processor 202 of the listing service computing device 200, etc.) to identify appropriate service providers from the compilation of service providers maintained by the listing service 110. In addition in the interface, results 604 of the search are displayed, based on the search, with ratings associated therewith. For example, in response to the search for a plumber at search feature 602, in the interface 600, the results 604 show ABC Plumber with a three and one-half star rating, and DEF Plumber with a two star rating.

While registration is required in the illustrated method 500, in other embodiments, access to compilations of service providers maintained by listing services may not require registration to the listing services. Instead, consumers may simply access websites or applications associated with the listing services, and then search for desired service providers (e.g., via an interface similar to the one shown in FIG. 6, etc.).

In addition, while the method 500 is described in connection with the consumer's portable communication device 116, it should be appreciated that the method 500 can be implemented in connection with any computing device associated with (or used by) the consumer 114 (i.e., the method 500 is not limited to the consumer's portable communication device 116).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations described herein.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for rating a target service provider based on transaction data for the target service provider, the method comprising:
accessing, by a computing device, transaction data for a payment account of a target service provider, the transaction data representing multiple transactions from the payment account, the transactions involving multiple merchants;
assigning, at the computing device, the target service provider to a group of other service providers, selected from multiple groups of other service providers, based on the transaction data for the payment account of the target service provider;
associating, at the computing device, a rating for the selected group with the target service provider; and
transmitting the rating.

2. The method of claim 1, wherein assigning the target service provider to a group of other service providers includes comparing the transaction data for the payment account of the target service provider to transaction data for payment accounts of the other service providers in the multiple groups, and assigning the target service provider to the selected group based on the comparison.

3. The method of claim 2, further comprising:
generating, by the computing device, at least one index for the selected group, the at least one index associated with at least one parameter of transaction data for the payment account of each of the service providers in the group; and
assigning, by the computing device, the rating to the group based on the at least one index.

4. The method of claim 3, wherein each of the merchants is associated with a merchant category code (MCC);
wherein generating the at least one index for the selected group includes generating a first index for the selected group for a first MCC; and
wherein the transaction data for the payment account of the target service provider represents at least one transaction involving a merchant associated with the first MCC.

5. The method of claim 4, wherein the at least one parameter associated with the at least one index includes at least one of an amount spent per transaction, a number of transactions made, a transaction location, a time of day and a day of week.

6. The method of claim 4, wherein generating the at least one index for the selected group further includes generating a second index for the selected group for a second MCC; and
wherein the transaction data for the payment account of the target service provider represents at least one transaction involving a merchant associated with the second MCC.

7. The method of claim 3, further comprising assigning the rating to the selected group based on a comparison of the at least one index generated for the selected group to at least one corresponding index for at least another one of the multiple groups.

8. The method of claim 3, wherein generating the at least one index for the selected group includes generating multiple indices for the selected group, each one of the multiple indices based on a different MCC.

9. The method of claim 1, further comprising receiving authorization from the target service provider to access the transaction data for the payment account; and
wherein transmitting the rating includes publishing the rating to a website associated with the target service provider.

10. A system for use in evaluating service providers based on transaction data for payment accounts associated with the service providers, the system comprising:
a memory including transaction data for multiple service providers, the transaction data including, for each of the multiple service providers, multiple transactions from payment accounts associated with the service providers, the multiple transactions involving multiple merchants; and
at least one processor coupled to the memory and, for each of the multiple service providers, configured to:
access transaction data for one or more of the multiple transactions for the service provider over a predefined interval;
bunch the accessed transaction data together based on a merchant category code (MCC) for the merchants involved in the one or more of the multiple transactions;
generate an index based, at least in part, on the bunched transaction data for the service provider;
associate a rating with the service provider, based on the index; and
publish the rating for the service provider.

11. The system of claim 10, wherein the at least one processor is configured to generate the index based on at least one parameter associated with the transaction data; and
wherein the at least one parameter includes at least one of a time of day, a day of a week, a location, and a frequency of transactions in the bunch.

12. The system of claim 10, wherein the at least one processor is configured to publish the rating in response to a request from a computing device hosting a listing website for the service provider.

13. The system of claim 10, wherein the at least one processor is configured to generate an index for each bunch of transaction data associated with a MCC included in a predefined list of MCCs of interest.

14. The system of claim 10, wherein the at least one processor is further configured to:
group the service provider together with other service providers based on transaction data for each of the service providers; and
assign the rating to the group.

15. The system of claim 14, wherein the index is associated with the group; and
wherein the at least one processor is configured to assign the rating to the group based on the index, as compared to corresponding indices associated with other groups.

16. A non-transitory computer readable media including executable instructions which, when executed by at least one processor, cause the at least one processor to:
correlate transactions from a payment account associated with a target service provider based on at least one parameter of the transactions;
generate at least one index for a group of service providers, including the target service provider, based at least in part on the correlated transactions; and
publish a rating for the target service provider based on the at least one index for the group, whereby the rating is indicative of at least one transactional behavior by the target service provider as compared to corresponding transactional behavior of other service providers in the group and to other service providers in other groups.

17. The computer readable media of claim 16, wherein the at least one parameter is a merchant category code; and
wherein the computer executable instructions, when executed by the at least one processor, further cause the at least one processor to generate the at least one index based on at least one of a frequency of the correlated transactions and an amount of one or more of the correlated transactions.

18. The computer readable media of claim 16, wherein the computer executable instruction, when executed by the at least one processor, further cause the at least one processor to correlate said transactions from said payment account, along with transactions from a second payment account associated with the target service provider, based on the at least one parameter.

19. The computer readable media of claim 16, wherein the computer executable instructions, when executed by the at least one processor, further cause the at least one processor to assign the rating to the group based on the at least one index of the group relative to corresponding indices of other groups of service providers.
